(19) United States
(12) Patent Application Publication
(10) Pub. No.: US 2007/0081497 A1
(43) Pub. Date: Apr. 12, 2007

(54) Method for improving intercellural transfers in cellular mobile radio communication systems

(75) Inventor: Nicolas Drevon, Paris (FR)

Correspondence Address: SUGHRUE MION, PLLC, 2100 PENNSYLVANIA AVENUE, N.W., SUITE 800, WASHINGTON, DC, 20037, US

(73) Assignee: EVOLIUM S.A.S.

(21) Appl. No.: 11/543,943

(22) Filed: Oct. 6, 2006

(30) Foreign Application Priority Data
Oct. 10, 2005 (FR) 0553064

(51) Int. Cl. H04Q 7/00

(52) U.S. Cl. 370/331; 455/436

(57) ABSTRACT

One aspect of the present invention is a method for improving intercellular transfers in cellular mobile radio communication systems, the method including at least one step in which a mobile radio communication network entity sends another mobile radio communication network entity, for an intercellular transfer from a first cell in which a set of simultaneous services per user is supported to a second cell in which a subset of said set of simultaneous services per user is supported, at least one information item for indicating simultaneity of services.

### CROSS-REFERENCE TO RELATED APPLICATIONS

This application is based on French Patent Application No. 0553064 filed Oct. 10, 2005, the disclosure of which is hereby incorporated by reference thereto in its entirety, and the priority of which is hereby claimed under 35 U.S.C. §119.

### BACKGROUND OF THE INVENTION

1. Field of the Invention

The present invention relates generally to mobile radio communication systems.

2. Description of the Prior Art

Generally speaking, mobile radio communication systems are covered by standards, and for more information reference may be made to the corresponding standards published by the corresponding standardization organizations.

The general architecture of such systems is described briefly with reference to FIG. 1. Such systems include a mobile radio communication network 1 communicating with mobile terminals 2 and with external networks (not specifically shown). The network 1 itself includes a radio access network (RAN) 3, primarily responsible for transmission and radio resource management at the radio interface between the network and the mobile terminals, and a core network (CN) 4, primarily responsible for routing and call management.

Changes in requirements and in technology generally lead to making a distinction between different types of radio access technologies and/or radio access networks. Examples of radio access technologies and/or radio access networks that may be cited include: TDMA (Time Division Multiple Access), W-CDMA (Wideband—Code Division Multiple Access), TD-SCDMA (Time Division—Synchronous Code Division Multiple Access), OFDM (Orthogonal Frequency Division Multiple Access), I-WLAN (Interworking Wireless Local Access Network), GAN (Generic Access Network), UMA (Unlicensed Mobile Access), etc.

Generally speaking, a distinction may be made between different types of radio access technologies and/or radio access networks according to whether or not they are capable of supporting a plurality of simultaneous services per user, i.e. according to whether or not they are capable of processing a plurality of radio access bearers (RAB) in parallel. Examples of simultaneous services that may be cited include in particular voice services, data services, circuit type services and packet type services.

Examples of systems capable of supporting a plurality of simultaneous services per user that may be cited include in particular the Universal Mobile Telecommunication System (UMTS).

Examples of systems that are not capable of supporting a plurality of simultaneous services per user that may be cited include the Global System for Mobile communication (GSM) in certain circumstances.

Moreover, in the case of systems such as the GSM/GPRS (Global System for Mobile communication/General Packet Radio Service), it is possible to use additional functions, such as the DTM (Dual Transfer Mode) function in particular, simultaneously supporting circuit services and packet services for the same user. It should be emphasized that the terminal of the user must also support the DTM function for the simultaneity of services to be operational.

Accordingly, generally speaking, in cellular mobile radio communication systems a distinction can be made between cells in which a plurality of simultaneous services per user are supported (corresponding to the situation of cells and terminals supporting appropriate additional functions and/or radio access technologies) and cells in which a plurality of simultaneous services per user are not supported (corresponding to the situation of cells or terminals not supporting appropriate additional functions and/or radio access technologies).

It must also be remembered that cell changing mechanisms are generally provided in these cellular systems. Of more particular interest hereinafter are intercellular transfer (handover) mechanisms.

Moreover, in systems including cells capable of supporting a plurality of simultaneous services per user and cells not capable of supporting a plurality of simultaneous services per user, intercellular transfers may be provided between the different cell types.

### SUMMARY OF THE INVENTION

In this context, we have noticed that problems can arise that for the sake of simplicity may be illustrated by means of an example.

Consider by way of example intersystem handover from a UMTS cell to a GSM/GPRS cell.

It will be remembered that in a GSM/GPRS type system a mobile terminal is called a mobile station (MS), the radio access network (RAN) is made up of subsystems called base station subsystems (BSS) and the core network (CN) includes, in particular, for the circuit switching domain (CS domain), 2G-MSC (2nd Generation Mobile Switching Center) type network elements and, for the packet switching domain (PS domain), 2G-SGSN (2nd Generation Serving GPRS Support Node) type network elements.

It will be remembered that in a UMTS type system a mobile terminal is called a user equipment (UE), the radio access network (RAN) is called the UMTS terrestrial radio access network (UTRAN), and the core network (CN) includes in particular, for the circuit switching domain (CS domain), 3G-MSC (3rd Generation Mobile Switching Center) type network elements and, for the packet switching domain (PS domain), 3G-SGSN (3rd Generation Serving GPRS Support Node) type network elements.

The principal steps of an intersystem handover, for example from a UMTS cell to a GSM/GPRS cell, are shown in FIG. 2.

In a step 5, a handover decision is taken by the UTRAN.

The method then includes a set of steps including, among others:
a step 6 corresponding to the sending by the UTRAN to the CN of a “Relocation Required” message,
a step 7 corresponding to the sending by the MSC to the BSS of a “Handover Request” message,
a step 8 of deciding to allocate resources, by the BSS, in the target cell.

It will be remembered that in a system such as the UMTS in particular a relocation procedure is initiated by the sending of a “Relocation Required” message by the radio access network entity responsible for the call (the serving radio network controller (SRNC)) to the appropriate core network (CN) entity, using the RANAP (Radio Access Network Application Part) protocol as defined in the 3GPP Technical Specification TS 25.413.

As illustrated by the step 6 in FIG. 2, the procedure of sending a “Relocation Required” message is used to initiate the execution of an intersystem handover from the UMTS to another system such as the GSM/GPRS in particular.

It will also be remembered that in a system such as the GSM/GPRS in particular, in the case of “external” handover, i.e. when the original cell and the target cell are not controlled by the same radio access network element, a “Handover Request” message is transmitted from the core network entity (MSC) responsible for the target cell to the radio access network entity (BSS) responsible for the target cell, following the reception by the core network entity responsible for the original cell of a “Handover Required” message transmitted by the radio access network entity responsible for the original cell, using the BSSMAP (Base Station Subsystem Management Application Part) protocol as defined in the 3GPP Technical Specification TS 48.008.

As indicated by the step 7 in FIG. 2, the procedure of sending a “Handover Request” message is used to execute an intersystem handover to the GSM/GPRS from another system such as the UMTS following the reception of a “Relocation Required” message as indicated above.

We have noticed that a new problem arises in this context, which may be stated in the following terms, for example.

If, because of lack of UMTS coverage, for example, handover to a GSM/GPRS cell is decided on by the UTRAN, under the present version of the standard there is no way for the BSS to determine if the user is simultaneously using a plurality of services, for example if the user is engaged in a circuit call and one or more packet sessions or only in a circuit call. In fact, according to the 3GPP Technical Specifications TS 23.009 and TS 25.413, the UTRAN initiates a handover for a circuit connection (CS handover) and if the user is engaged simultaneously in one or more packet sessions the packet session(s) (PS sessions) is or are taken over at the initiative of the mobile terminal in the GSM/GPRS network.

However, if the mobile terminal and/or the BSS do not support the DTM function, the packet session(s) cannot normally be taken over before terminating the circuit call. The packet session(s) can, however, be taken over before terminating the circuit connection if UMTS coverage resumes and a handover to the UMTS is then decided on by the BSS.

However, as indicated above, under the present version of the standard the BSS does not know if the user is engaged only in a circuit call or simultaneously in a circuit call and one or more packet sessions. Consequently, the decision taken by the BSS (for this handover to the UMTS) is not the optimum. For example, if the user is engaged only in a circuit call, it may be preferable for the mobile terminal to remain in the GSM network to minimize the number of handovers. On the other hand, if the user is simultaneously engaged in a circuit call and in one or more packet sessions, it may be preferable to effect a handover to the UMTS to enable the user to resume simultaneously the circuit call and the packet session(s).

In other words, under the present version of the standard the situation of intersystem handover is not dealt with optimally, in particular for the reasons explained above by means of an example, and this results in degraded performance, in particular in terms of quality of service.

We have also noticed that this type of problem arises for any handover from a first cell in which a set of simultaneous services per user is supported to a second cell in which a subset of said set of simultaneous services per user is supported.

A particular object of the present invention is to solve some or all of the above problems and/or to avoid some or all of the above drawbacks. More generally, one object of the present invention is to improve performance and quality of service in such systems.

One aspect of the present invention consists in a method for improving intercellular transfers in cellular mobile radio communication systems, said method including at least one step in which a mobile radio communication network entity sends another mobile radio communication network entity, for an intercellular transfer from a first cell in which a plurality of simultaneous services per user are supported to a second cell in which a plurality of simultaneous services per user are not supported, at least one information item for indicating simultaneity of services.

More generally, one aspect of the present invention is a method for improving intercellular transfers in cellular mobile radio communication systems, said method including at least one step in which a mobile radio communication network entity sends another mobile radio communication network entity, for an intercellular transfer from a first cell in which a set of simultaneous services per user is supported to a second cell in which a subset of said set of simultaneous services per user is supported, at least one information item for indicating simultaneity of services.

Another aspect of the present invention is a radio access network entity for a mobile radio communication network, including means for implementing a method according to the invention.

Another aspect of the present invention consists in a mobile radio communication network radio access network entity including means for sending a core network entity, for an intercellular transfer from a first cell capable of supporting a plurality of simultaneous services per user to a second cell not capable of supporting a plurality of simultaneous services per user, at least one information item for indicating simultaneity of services.

More generally, another aspect of the present invention consists in a mobile radio communication network radio access network entity including means for sending a core network entity, for an intercellular transfer from a first cell capable of supporting a set of simultaneous services per user to a second cell capable of supporting a subset of said set of simultaneous services per user, at least one information item for indicating simultaneity of services.

Another aspect of the present invention consists in a mobile radio communication network radio access network entity including means for using at least one information item for indicating simultaneity of services received from a core network entity, for an intercellular transfer from a first cell capable of supporting a plurality of simultaneous services per user to a second cell not capable of supporting a plurality of simultaneous services per user, to decide afterwards on possible intercellular transfer to a cell able to support a plurality of simultaneous services per user.

More generally, another aspect of the present invention consists in a mobile radio communication network radio access network entity including means for using at least one information item for indicating simultaneity of services received from a core network entity, for an intercellular transfer from a first cell capable of supporting a set of simultaneous services per user to a second cell capable of supporting a subset of said set of simultaneous services per user, to decide afterwards on possible intercellular transfer to a cell able to support a set of simultaneous services per user.

A further aspect of the present invention is a core network entity for a mobile radio communication network, including means for implementing a method according to the invention.

Another aspect of the present invention consists in a mobile radio communication network core network entity including means for sending a radio access network entity, for an intercellular transfer from a first cell capable of supporting a plurality of simultaneous services per user to a second cell not capable of supporting a plurality of simultaneous services per user, at least one information item for indicating simultaneity of services.

More generally, another aspect of the present invention consists in a mobile radio communication network core network entity including means for sending a radio access network entity, for an intercellular transfer from a first cell capable of supporting a set of simultaneous services per user to a second cell capable of supporting a subset of said set of simultaneous services per user, at least one information item for indicating simultaneity of services.

A further aspect of the invention is a mobile radio communication system including at least one mobile radio communication network entity according to the invention.

Other aspects and features of the present invention will become apparent on reading the following description of embodiments of the invention given with reference to the appended figures.

### BRIEF DESCRIPTION OF THE DRAWINGS

FIG. 1 outlines the general architecture of a cellular mobile radio communication system.

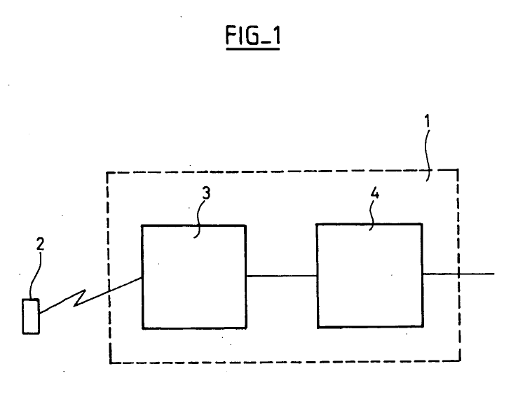

FIG. 2 shows one example of a prior art intersystem handover method.

FIG. 3 shows one example of an intersystem handover method of the invention.

### DETAILED DESCRIPTION OF THE PREFERRED EMBODIMENT

The invention is more particularly described hereinafter, by way of example, in the situation of intersystem handover from a UMTS cell to a GSM/GPRS cell and in the case of simultaneous services corresponding to circuit type services and packet type services. However, as indicated above, the invention is not limited to this kind of example.

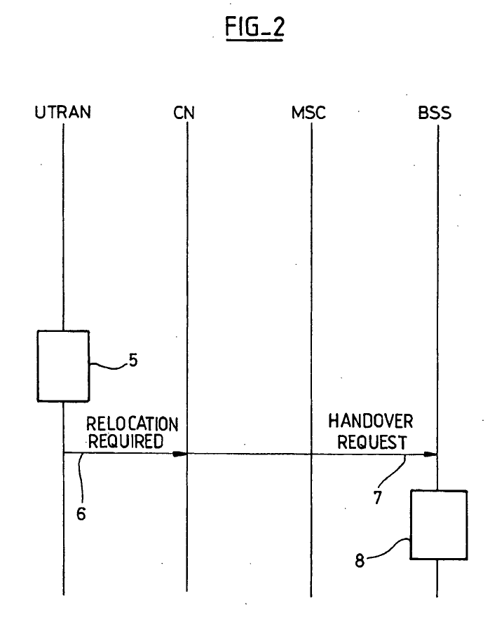

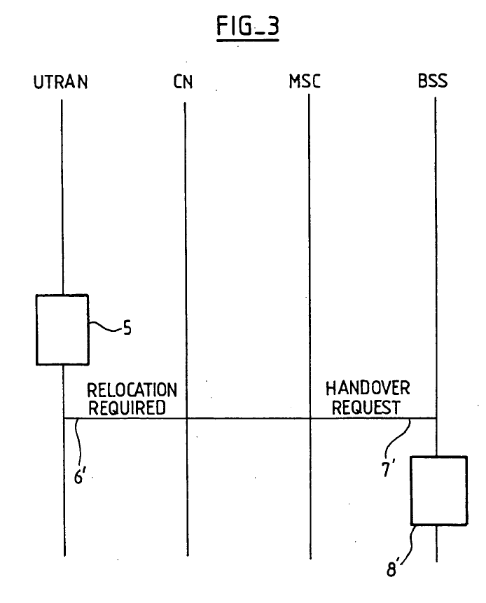

One example of a method according to the invention is shown in FIG. 3. Elements common to FIGS. 2 and 3 are denoted by the same reference numbers.

The method shown in FIG. 3 includes a step 6′ which differs from the step 6 of FIG. 2 in that an information item, for example a “PS session indication” that indicates if the user is engaged only in a circuit call or simultaneously in a circuit call and one or more packet sessions, is sent in the RANAP “Relocation Required” message. This information item is relayed by the core network to the BSS in the BSSMAP “Handover Request” message, as shown in the step 7′ in FIG. 3.

For example, this information item could be contained in an information element (IE) such as the “Old BSS to New BSS information” IE, for example, or any other container for transferring information from the UTRAN to the BSS in a manner that is transparent for the core network. In the case of intersystem handover, the “Old BSS to New BSS information” IE is contained in the “Relocation Required” message as defined in the 3GPP Technical Specification TS 25.413 and in the “Handover Request” message as defined in the 3GPP Technical Specification TS 48.008.

In the step denoted 8′ in FIG. 3, the BSS is then capable of taking a better decision regarding handover to the UMTS if UMTS coverage resumes afterwards.

Another aspect of the present invention is a radio access network entity including means for implementing a method according to the invention.

A further aspect of the present invention is a core network entity including means for implementing a method according to the invention.

In the case of intersystem handover, for example, from a first cell corresponding to a UMTS cell to a second cell corresponding to a GSM/GPRS cell, and for the situation of simultaneous services corresponding to circuit type services and packet type services:
in the UMTS, a UTRAN or radio access network entity, such as in particular an RNC (Radio Network Controller) type entity, responsible for the first cell, may include means for sending a core network entity of that system, such as in particular a 3G-MSC (3rd Generation Mobile Switching Center) type entity, responsible for the first cell, at least one information item for indicating if the user is engaged only in a circuit call or simultaneously in a circuit call and in one or more packet sessions. Such means may in particular include means for sending this kind of information item in a “Relocation Required” message as defined in the 3GPP Technical Specification TS 25.413, in particular in an information element of this kind of message corresponding to the “Old BSS to New BSS information” IE or any other container for transferring information from UTRAN to BSS in a manner that it is transparent for the core network.

For example, in the case of handover from a first cell corresponding to a GSM/GPRS cell adapted to support a plurality of simultaneous services per user to a second cell corresponding to a GSM/GPRS cell, and for the situation of simultaneous services corresponding to circuit type services and packet type services:
in the GSM/GPRS system, a BSS or radio access network entity, such as in particular a BSC (Base Station Controller) type entity, responsible for the first cell, may include means for sending a core network entity of this system, such as in particular a 2G-MSC (2nd Generation Mobile Switching Center) type entity, at least one information item for indicating if the user is engaged only in a circuit call or simultaneously in a circuit call and in one or more packet sessions. Such means may in particular include means for sending this kind of information item in a “Handover Required” message as defined in the 3GPP Technical Specification TS 48.008, in particular in an information element of this kind of message corresponding to the “Old BSS to New BSS information” IE.

For example, in the case of handover from a first cell that may correspond to a UMTS cell or to a GSM/GPRS cell adapted to support a plurality of simultaneous services per user to a second cell corresponding to a GSM/GPRS cell and for the situation of simultaneous services corresponding to circuit type services and packet type services:
in the GSM/GPRS system, a core network entity, such as in particular a 2G-MSC (2nd Generation Mobile Switching Center) type entity, responsible for the second cell, may include, in particular, means for sending a BSS or radio access network entity, such as in particular a BSC (Base Station Controller) type entity, responsible for the second cell, at least one information item for indicating if the user is engaged only in a circuit call or simultaneously in a circuit call and in one or more packet sessions. Such means may in particular include means for sending such information in a “Handover Request” message, in particular in an information element of this kind of message corresponding to the “Old BSS to New BSS information ” IE or any other container for transferring information from UTRAN to BSS in a manner that is transparent for the core network.

For example, in the case of handover from a first cell that may correspond to a UMTS cell or to a GSM/GPRS cell adapted to support a plurality of simultaneous services per user to a second cell corresponding to a GSM/GPRS cell and for the situation of simultaneous services corresponding to circuit type services and to packet type services:
in the GSM/GPRS system, a BSS or radio access network entity, such as in particular a BSC (Base Station Controller) type entity, responsible for the second cell, may include means for processing at least one information item received from a core network entity such as in particular a 2G-MSC (2nd Generation Mobile Switching Center) type entity, responsible for the second cell, and for indicating if the user is engaged only in a circuit call or simultaneously in a circuit call and in one or more packet sessions, to decide afterwards on possible handover to a cell adapted to support a plurality of simultaneous services per user.

The particular implementation of such means presenting no particular difficulty to the person skilled in the art, such means need not be described here in more detail than by their function, as above.

There is claimed:

1. A method for improving intercellular transfers in cellular mobile radio communication systems, said method including at least one step in which a mobile radio communication network entity sends another mobile radio communication network entity, for an intercellular transfer from a first cell in which a set of simultaneous services per user is supported to a second cell in which a subset of said set of simultaneous services per user is supported, at least one information item for indicating simultaneity of services.

2. The method claimed in claim 1, including, in the case of a first cell of UMTS type, respectively of GSM/GPRS type supporting a set of simultaneous services per user, at least one step in which a radio access network entity responsible for the first cell sends a core network entity responsible for the first cell, in a “Relocation Required” type message as defined in the RANAP protocol, respectively a “Handover Required” type message as defined in the BSSMAP protocol, an information element containing an information item for indicating simultaneity of services.

3. The method claimed in claim 2, wherein said information element corresponds to the “Old BSS to new BSS information” IE or to any other container for transferring information from UTRAN to BSS in a manner that is transparent for the core network.

4. The method claimed in claim 1, including, in the case of a second cell of GSM type, at least one step in which a core network entity responsible for the second cell sends a radio access network entity responsible for the second cell, in a “Handover Request” type message as defined in the BSSMAP protocol, an information element containing an information item for indicating simultaneity of services.

5. The method claimed in claim 4, wherein said information element corresponds to the “Old BSS to new BSS information” IE.

6. The method claimed in claim 1, wherein said information item for indicating simultaneity of services is used, in a radio access network entity responsible for the second cell, for deciding afterwards on a possible transfer to a cell supporting a plurality of simultaneous services per user.

7. A mobile radio communication network radio access network entity including means for sending a core network entity, for an intercellular transfer from a first cell capable of supporting a set of simultaneous services per user to a second cell capable of supporting a subset of said set of simultaneous services per user, at least one information item for indicating simultaneity of services.

8. The radio access network entity claimed in claim 7, including means for sending a core network entity, in a “Relocation Required” type message as defined in the RANAP protocol, respectively a “Handover Required” type message as defined in the BSSMAP protocol, at least one information item for indicating simultaneity of services.

9. The entity claimed in claim 8, wherein said information item is sent in an information element corresponding to the “Old BSS to new BSS information” IE or any other container for transferring information from UTRAN to BSS in a manner that is transparent for the core network.

10. A mobile radio communication network core network entity including means for sending a radio access network entity, for an intercellular transfer from a first cell capable of supporting a set of simultaneous services per user to a second cell capable of supporting a subset of said set of simultaneous services per user, at least one information item for indicating simultaneity of services.

11. The entity claimed in claim 10, including means for sending a radio access network entity, in a “Handover Request” type message as defined in the BSSMAP protocol, at least one information item for indicating simultaneity of services.

12. The entity claimed in claim 11, wherein said information item is transmitted in an information element corresponding to the “Old BSS to new BSS information” IE or any other container for transferring information from UTRAN to BSS in a manner that is transparent for the core network.

13. A mobile radio communication network radio access network entity including means for processing at least one information item for indicating simultaneity of services received from a core network entity, for an intercellular transfer from a first cell capable of supporting a set of simultaneous services per user to a second cell capable of supporting a subset of said set of simultaneous services per user, to decide afterwards on possible intercellular transfer to a cell able to support a set of simultaneous services per user.
